(19) United States
(12) Patent Application Publication
(10) Pub. No.: US 2023/0127614 A1
(43) Pub. Date: Apr. 27, 2023

(54) SYSTEMS AND METHODS FOR PROTOTYPE GENERATION

(71) Applicant: Toyota Research Institute, Inc., Los Altos, CA (US)

(72) Inventors: Yue Weng, San Mateo, CA (US); Emily Sumner, Berkeley, CA (US); Shabnam Hakimi, Chapel Hill, NC (US); Nikos Arechiga, San Mateo, CA (US); Jonathan A. DeCastro, Arlington, MA (US)

(73) Assignee: Toyota Research Institute, Inc., Los Altos, CA (US)

(21) Appl. No.: 17/507,187

(22) Filed: Oct. 21, 2021

(51) Int. Cl. G06N 3/04; G06K 9/62; G06Q 30/02

(52) U.S. Cl. CPC G06N 3/0454; G06K 9/6257; G06K 9/623; G06Q 30/0202

(57) ABSTRACT

Systems and methods for generating prototypes are disclosed. In one embodiment, a computer-implemented method of creating a prototype includes receiving one or more input design parameters, generating, using a first neural network, a plurality of prototypes based on the one or more input design parameters, generating, using a second neural network, one or more decoy prototypes, and presenting, by an electronic display, a report including at least a portion of the plurality of prototypes and at least one of the one or more decoy prototypes.

### TECHNICAL FIELD

The present specification generally relates to product design and, more particularly, to systems and methods for automatically generating an initial set of prototypes for consideration during the design process.

### BACKGROUND

The classic design process relies heavily on the designer's creativity and skills to create prototypes that may become a product. The design process is not only constrained by the designer's own preferences that is often very limited, but also time consuming. Furthermore, a prototype can be turned down for reasons like competitive disadvantage to other companies or brands, which would further prolong the whole process. It can be quite time consuming and expensive to need to “start from scratch” after fully developing a prototype due to perceived negatives with respect to the prototype.

Accordingly, a need exists for alternative systems and methods for developing prototypes.

### SUMMARY

In one embodiment, a computer-implemented method of creating a prototype includes receiving one or more input design parameters, generating, using a first neural network, a plurality of prototypes based on the one or more input design parameters, generating, using a second neural network, one or more decoy prototypes, and presenting, by an electronic display, a report including at least a portion of the plurality of prototypes and at least one of the one or more decoy prototypes.

In another embodiment, a system for creating a prototype includes one or more processors, an electronic display, and one or more non-transitory memory modules storing computer-readable instructions. The computer-readable instructions, when executed, cause the one or more processors to receive one or more input design parameters, generate, using a first neural network, a plurality of prototypes based on the one or more input design parameters, generate, using a second neural network, one or more decoy prototypes, and present, by the electronic display, a report including at least a portion of the plurality of prototypes and at least one of the one or more decoy prototypes.

In yet another embodiment, a computer-implemented method of fabricating a prototype includes providing, to a first neural network, one or more input design parameters, receiving, from the first neural network, a plurality of prototypes based on the one or more input design parameters, receiving, from a second neural network, one or more decoy prototypes based at least in part on the one or more input design parameters, and fabricating at least one select prototype of the plurality of prototypes and the one or more decoy prototypes.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example system for producing a plurality of prototypes according to one or more embodiments described and illustrated herein;

FIG. 2 schematically depicts another view of an example system for producing a plurality of prototypes according to one or more embodiments described and illustrated herein;

FIG. 3. schematically depicts an example neural network for scoring and ranking prototypes according to one or more embodiments described and illustrated herein;

FIG. 4 schematically ally depicts two vehicles and a decoy vehicle according to one or more embodiments described and illustrated herein;

FIG. 5 schematically depicts a computer system for producing a plurality of prototypes according to one or more embodiments described and illustrated herein;

FIG. 6 schematically depicts an example method for generating a report including a plurality of prototypes according to one or more embodiments described and illustrated herein; and

FIG. 7 schematically depicts an example method for fabricating a prototype according to one or more embodiments described and illustrated herein.

### DETAILED DESCRIPTION

Referring generally to the appended figures, embodiments of the present disclosure are directed to systems and methods for generating prototypes. The design process for designing a product can be very long and costly. Oftentimes designers create many, many different designs, many of which have negative aspects that prevent them from ever coming to market. The creation of prototypes take a significant amount of time, which delays the launch of the product that is being designed. Additionally, designers are limited to their own skill, experience, and preferences. There may be viable prototypes for products that are never realized because the designers never thought of such designed.

Embodiments of the present disclosure automate the early portion of the design process by automatically generating a plurality of designs for consideration by a designer. At the beginning of the design process, the designer generally knows the parameters of the product she is designing. For example, she may know the general dimensions, possible colors, potential functionalities, shapes, and the like. The systems and methods described herein take this knowledge of the product as input in the form of input design parameters, which may be a written description of a product, values provided in an input form, and/or images of similar products. The systems and methods described herein then automatically generate a plurality of prototypes meeting the input design parameters but each having differences, such as differences in size, shape, color and the like. The prototypes that are outputted may be used as inspiration for the designer. For example the designer may select one or more prototypes to further tweak and design to arrive at the ultimate product that is manufactured and sold. Thus, the embodiments described herein significantly speed up the design process by giving the designer a launching point for which to start her design process.

Additionally, some embodiments also generate one or more decoy prototypes. A decoy is a product that is meant to drive sales to some other product. For example, if there are two products for sale in the market place, one made by a competitor and one made by the company designing the new product, the decoy prototype may have attributes that drive sales to the product made by the company designing the new product. Or, the company may be designing three variations of the product, and the decoy product is a product that is meant to drive sales to the variation of the product that produces the most revenue.

Various embodiments for systems and methods for generating prototypes are described in detail below.

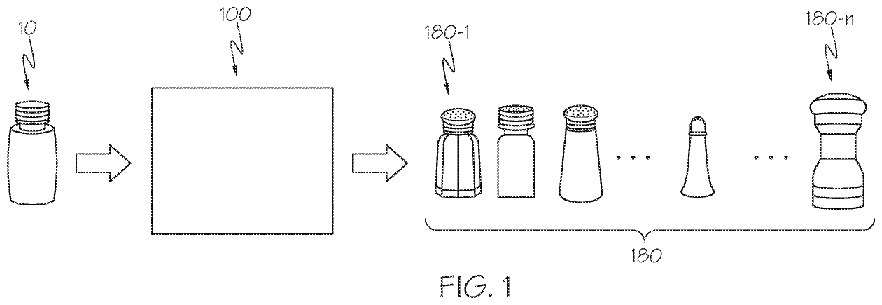

Referring now to FIG. 1, an example system 100 for producing a plurality of prototypes and one or more decoy prototypes is schematically illustrated. The system 100 may be implemented by a computing device, such as a personal computer, a laptop computer, a tablet, a smartphone, and the like. Generally, the system 100 is configured to receive one or more input design parameters 10 relating to a product in which a designer is desiring to design. As described in more detail below, the system 100 takes the input design parameters 10 and generates a plurality of prototypes 180 that are outputted. The plurality of prototypes 180 includes potential prototypes with variations on the input design parameters 10 that are inputted into the system 100.

A user of the system 100 may then view the plurality of prototypes 180 and select one or more as an initial design. The plurality of prototypes 180 may include prototype configurations that the designer would not have come up with on her own. Thus, the system 100 can quickly and efficiently enhance the product development process by creating initial designs.

In the illustrated example, the product being designed is a salt shaker. The designer provides input design parameters regarding the salt shaker she wishes to create. The input design parameters 10 may be any parameter describing the product. In the salt shaker example, the parameters may be dimensions, shape, materials, dispensing rate, color, and the like. The input design parameters 10 may be text based (e.g., a written description of the parameters) and also may include one or more images. In the present example, the input design parameters 10 may include an image of a salt shaker. The input design parameters 10 may include single values (e.g., a height of 7 cm) or a range of values (e.g., a height within a range of 3 cm to 8 cm).

The plurality of prototypes include a salt shaker 180-1 to salt shaker 180-N. Any number of prototypes may be created. The prototype salt shakers that are created vary among the different parameters that were inputted by the user. For example, salt shaker 180-1 has a short, squat shape while salt shaker 180-N is taller and incorporates a salt grinder function. A report listing all of the salt shakers may be reviewed by the designer, who may then select one or more to use as an initial design.

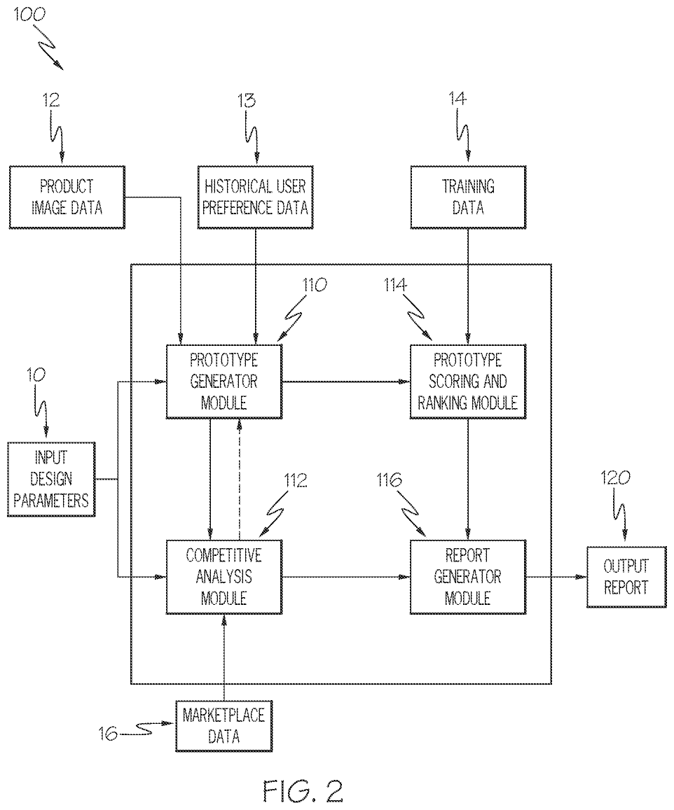

Referring now to FIG. 2, the system 100 shown in FIG. 1 is illustrated in greater detail. The example system 100 includes a prototype generator module 110, a competitive analysis module 112, a prototype scoring and ranking module 114, and a report generator module 116.

The prototype generator module 110 receives input design parameters 10 as input and outputs a plurality of prototypes. The prototype generator module 110 is a neural network that is configured to produce the plurality of prototypes based on the input design parameters 10. Embodiments are not limited by the type of neural network that is used by the prototype generator module 110 to produce the plurality of prototypes.

As a non-limiting example, the prototype generator module 110 is configured as a generative adversarial network (GAN) (also referred to herein as a first neural network). In this example, the prototype generator module 110 receives training data, such as, for example, in the form of existing product image data 12. The existing product image data 12 comprises images of currently existing products. In the salt shaker example, the existing product image data include images of salt shakers that have previously been manufactured. Images of salt shakers of all shapes and sizes may be included. In some embodiments, the prototype generator module 110 may also receive historical user preference data. The historical user preference data 13 may include data regarding preferences of consumers regarding the particular products. As a non-limiting example, historical user preference data 13 may include consumer data and reliability data.

The GAN of the prototype generator module 110 includes a generator that generates candidate prototypes and a discriminator that classifies whether or not the candidate prototypes that are generated are real or fake. The input design parameters 10 include a product type description. In the present example, the product type is a salt shaker. At training time, the prototype generator module 110 may perform an Internet image search for existing salt shakers. Additionally or alternatively, a user may provide the images of the existing products to the prototype generator module 110.

As stated above, the input design parameters include parameters that define the product that is being designed. These input design parameters 10 may be used to find existing product image data 12. For example, the input design parameters may define a certain product, a color of the product, a shape of the product, a size of the product, and the like. The prototype generator module 110 may then use these input design parameters 10 to find exiting product image data 12 that meets the input design parameters 10. For example, the input design parameters 10 may list a salt shaker made of clear glass, having a height between 3 and 5 cm and having a circular bottom. These input design parameters 10 are then used to find images meeting the parameters. In another example, many potential images are created and the input design parameters 10 are used as a filter to filter out potential images that do not satisfy the input design parameters 10.

The generator of the GAN prototype generator module 110 uses the product image data 12 as a training set to generate the plurality of prototypes. Candidate prototypes are generated by the generator.

The GAN prototype generator module 110 further includes a discriminator that is trained on the product image data 12 and/or the historical user preference data 13 to determine whether or not candidate prototypes generated by the generator are real or fake (i.e., created by the generator). A candidate prototype may be selected as one of the plurality of prototypes outputted by the prototype generator module 110 when the discriminator cannot determine if the particular candidate prototype is real or fake. Many different prototypes may be outputted by the prototype generator module 110. Parameters of the prototype may be slightly perturbed to generate different styles or configurations of products.

In some embodiments, the historical user preference data 13 may be used to filter out undesirable prototypes that should not be provided for various reasons. For example, user preference data may suggest that certain configurations of a product are not desirable, or have reliability concerns. In this manner, undesirable prototypes may be filtered out and not outputted by the prototype generator module 110.

It should be understood that generative models other than GANs may be used by the prototype generator module 110 to generate the plurality of prototypes, and that embodiments are not limited to GANs.

Still referring to FIG. 2, the plurality of prototypes outputted by the prototype generator module 110 are provided as input into a prototype scoring and ranking module 114. The output of prototype scoring and ranking module 114 is a list of ranked prototypes. The prototype scoring and ranking module 114 may score each prototype based on one or more factors. Factors may include manufacturability, consumer preference, price, sales data, and the like. Any method of scoring and ranking the plurality of prototypes may be used.

In one example, the prototype scoring and ranking module 114 comprises a feed-forward or recurrent neural network that is trained using training data 14.

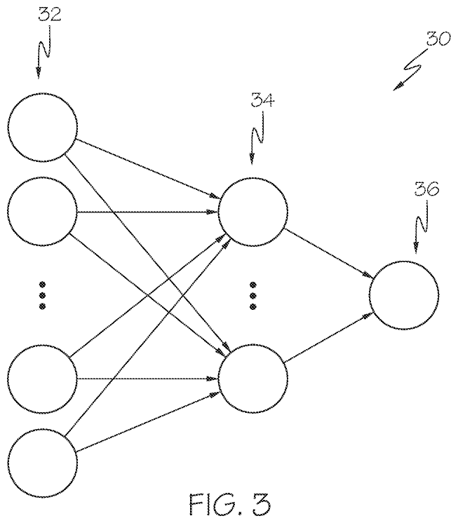

An architecture of an example feed-forward neural network 30 is shown in FIG. 3. The feed-forward neural network 30 of FIG. 3 comprises an input layer 32, a hidden layer 34, and an output layer 36. However, it should be understood that the feed-forward neural network 30 may contain any number of hidden layers. It should also be understood that the input layer 32, the hidden layer 34, and any other hidden layers of the feed-forward neural network 30 may each have any number of nodes. Each directed edge of the feed-forward neural network 30 may have an attached weight, which is a parameter that may be learned during training of the feed-forward neural network 30.

The input layer 32 of the feed-forward neural network 30 may receive inputs comprising a set of features. The output layer 36 of the feed-forward neural network 30 may output a predicted score based on the plurality of prototypes inputted into the feed-forward neural network 30.

The training data 14 for the prototype scoring and ranking module 114 includes historical data regarding the factors in which the prototypes are to be ranked. For example, one factor may be manufacturability of the product. The training data 14 may be in the form of survey data whereby engineers or other personnel were surveyed to provide their opinions as to the manufacturability of a product. The training data 14 includes a set of features and a ground truth label. In the manufacturability example, the set of features may include attributes of a particular product, such as number of parts, size, shape, material and the like. The ground truth label for a training example may be a score that the engineer applied to particular product with respect to manufacturability. The engineer may have provided an integer on a scale (e.g., 1 to 10) or a YES or NO value. The training data 14 may include ground truth labels for other factors, such as pricing data wherein the ground truth label is a price of the product on a certain day.

The trained prototype scoring and ranking module 114 then receives the plurality of prototypes and predicts an overall score of each prototype. The overall score may be a composite score based on scores for the individual factors. For example, the overall score may include individual scores for manufacturability, consumer preference, price, sales data, and the like. As a non-limiting example, the overall score is a summation of the individual scores. As another non-limiting example, the overall score is an average of the individual scores. In some embodiments, factors may be weighted. For example, the consumer preference factor may be more greatly weighted than the manufacturability factor. The prototype scoring and ranking module 114 then ranks the plurality of prototypes based on overall score.

It should be understood the method of scoring and ranking prototypes provided above is merely an example. Other known or yet-to-be-developed methods of scoring and ranking the plurality of prototypes may be utilized.

Referring again to FIG. 2, the system may further include a competitive analysis module 112. However, in other embodiments, no competitive analysis module is provided. The function of the competitive analysis module 112 is to predict one or more decoys for the product that is currently being designed. The decoy effect is a marketing strategy that is defined by the phenomenon that consumers will tend to have a specific change in preference between two options when also presented with a third option that is asymmetrically dominated. For example, a decoy may be a medium sized drink that is sized between a small drink and a large drink but the medium sized drink is priced close to the price of the large drink. Many consumers will opt for the large drink because of the perceived value based on the comparison with the medium drink. The competitive analysis module predicts one or more decoys prototypes.

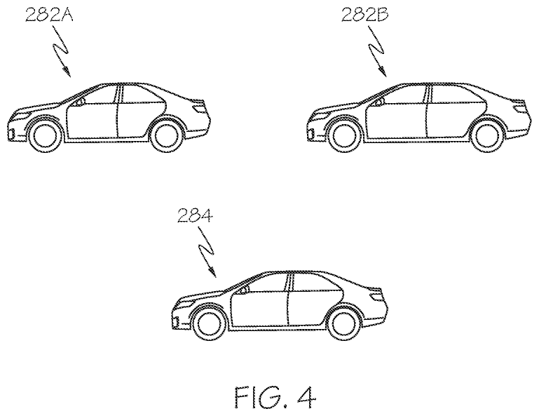

Referring now to FIG. 4, a vehicle decoy example is illustrated. In the illustrated example, there is a first vehicle 282A and a second vehicle 282B, which are both commercially available. Each vehicle has certain features. For example, the first vehicle 282A is shorter in length and taller in height than the second vehicle 282B. The competitive analysis module 112 has developed a decoy prototype vehicle 282 that will hopefully drive additional sales to either the first vehicle 282A or the second vehicle 282B. In one example, a decoy prototype may be generated to drive sales away from a competitor.

The competitive analysis module 112 is a preference predictor that predicts the preference of products by consumers to predict one or more decoy prototypes. The one or more decoy prototypes are designed to drive consumers to one or more other products. For example, the one or more decoy prototypes may be designed to drive sales to the second vehicle 282B.

As a non-limiting example, the competitive analysis module 112 is a neural network (i.e., a second neural network) trained using marketplace data 16 to predict one or more decoy prototypes. The marketplace data 16 includes parameters of products in the category of the product that is being designed (e.g., a salt shaker, a vehicle, and the like). The parameters may include, without limitation, color, dimensions, shape, options, design, and the like. The marketplace data 16 further includes sales data for the different products in the category. The marketplace data 16 may further include consumer behavior data relating to how and why consumers make the choices they do when purchasing a product. Thus, the competitive analysis module 112 may be trained to predict a preference of products based on the marketplace data 16.

The input design parameters may also include one or more existing products that the designer wishes to predict a decoy for. For example, the exiting products may be the first vehicle 282A and the second vehicle 282B. The input design parameters include parameters of the two particular products as described above (color, dimensions, shape, options, design, and the like) as well as sales data and any other data relevant to preference prediction.

Using the neural network trained on the marketplace data 16, the competitive analysis module 112 creates one or more decoy prototypes that drive consumer preference, and therefore sales, to a selected product. In the vehicle example, the designer may instruct the competitive analysis module 112 to create one or more decoy prototypes to drive sales to the second vehicle 282B. This may be accomplished by selecting one or more real products and/or one or more prototypes, such as the prototypes generated by the prototype generator module. As an example, the two selected products/prototypes may be the first vehicle 282A and the second vehicle 282B, which may be prototypes that were generated by the prototype generator module 110 or actual production models. Next, a random initialization for a decoy prototype is generated. For example, the random initialization may be performed by generating a copy of the second vehicle 282B and its features. This initialized decoy is the basis for the ultimate decoy that will be created.

Next, backpropagation is used to modify the initial decoy prototype so that it has the desired effect on the market scores of the other prototypes. For example, suppose that the desired effect is for the decoy prototype to drive sales away from 282B and towards 282A. Then, holding fixed the parameters of the neural network, the decoy prototype is modified in the gradient direction that increases the marketability score of 282A and decreases the marketability score of 282B by backpropagation through the network.

In some embodiments, the one or more decoy prototypes are fed back to the prototype generator module 110 for use by the prototype generator module in creating the plurality of prototypes.

Still referring to FIG. 2, the one or more decoy prototypes and the plurality of prototypes that are scored and/or ranked are provided to the report generator module 116. The report generator module 116 packages the information regarding the one or more decoy prototypes and the plurality of prototypes into a report 120 that is beneficial to the user. Embodiments are not limited by any particular format for the report. As a non-limiting example, the report 120 may include a ranked listed of prototypes along with corresponding images, as well as the one or more decoy prototypes along with corresponding images. At a glance, the designer may see many different prototypes to choose from. These prototypes may provide the designer with good ideas as to where to take the design. She may select one or more of the prototypes as a base for further design and ultimately production of the product. The report 120 may be displayed on an electronic display, for example.

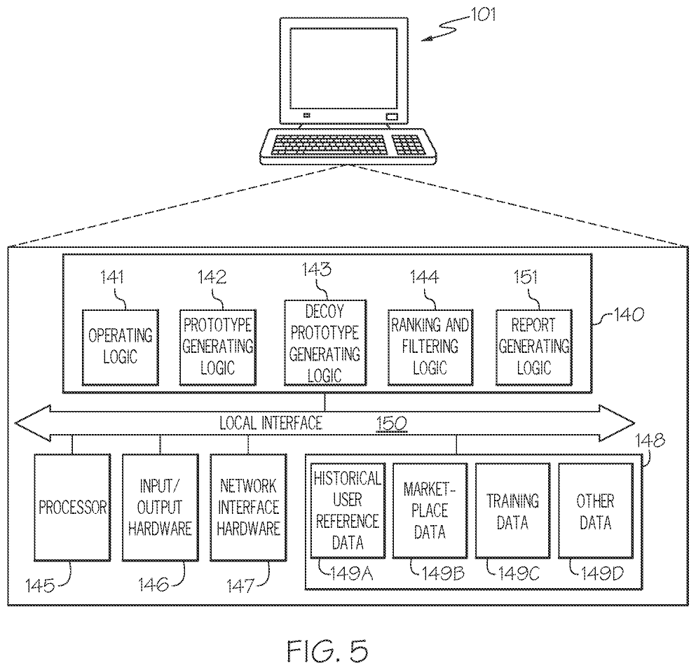

Embodiments of the present disclosure may be implemented by a computing device, and may be embodied as computer-readable instructions stored on a non-transitory memory device. Referring now to FIG. 5 an example system for generating a plurality of prototypes configured as a computing device 101 is schematically illustrated. The example computing device 101 provides a system for generated prototypes, and/or a non-transitory computer usable medium having computer readable program code for generating prototypes embodied as hardware, software, and/or firmware, according to embodiments shown and described herein. While in some embodiments, the computing device 101 may be configured as a general purpose computer with the requisite hardware, software, and/or firmware, in some embodiments, the computing device 101 may be configured as a special purpose computer designed specifically for performing the functionality described herein. It should be understood that the software, -hardware, and/or firmware components depicted in FIG. 5 may also be provided in other computing devices external to the computing device 101 (e.g., data storage devices, remote server computing devices, and the like).

As also illustrated in FIG. 5, the computing device 101 (or other additional computing devices) may include a processor 145, input/output hardware 146, network interface hardware 147, a data storage component 148 (which may include historical user preference data 149A (i.e., any data needed by the first neural network of the prototype generator module 110), marketplace data 149B (i.e., any data needed by the second neural network of the competitive analysis module 112), training data 149C (i.e., any data for use by the prototype scoring and ranking module), and any other data 149D for performing the functionalities described herein), and a non-transitory memory component 140. The memory component 140 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 140 may be configured to store operating logic 141, prototype generating logic 142 for generating a plurality of prototypes, decoy prototype generating logic 143 for generating decoy prototypes, and scoring and ranking logic for scoring and ranking prototypes as described herein (each of which may be embodied as computer readable program code, firmware, or hardware, as an example). It should be understood that the data storage component 148 may reside local to and/or remote from the computing device 101, and may be configured to store one or more pieces of data for access by the computing device 101 and/or other components.

A local interface 150 is also included in FIG. 5 and may be implemented as a bus or other interface to facilitate communication among the components of the computing device 101.

The processor 145 may include any processing component configured to receive and execute computer readable code instructions (such as from the data storage component 148 and/or memory component 140). The input/output hardware 146 may include a graphics display device, keyboard, mouse, printer, camera, microphone, speaker, touch-screen, and/or other device for receiving, sending, and/or presenting data. The network interface hardware 147 may include any wired or wireless networking hardware, such as a modem, LAN port, wireless fidelity (Wi-Fi) card, WiMax card, mobile communications hardware, and/or other hardware for communicating with other networks and/or devices.

Included in the memory component 140 may be the store operating logic 141, prototype generating logic 142, decoy prototype generating logic 143, and scoring and ranking logic 144. The operating logic 141 may include an operating system and/or other software for managing components of the computing device 101. The operating logic 141 may also include computer readable program code for displaying the graphical user interface used by the user to input design parameters and review reports. Similarly, the prototype generating logic 142 may reside in the memory component 140 and may be configured to generate a plurality of prototypes (e.g., first neural network logic to generate the plurality of prototypes). The decoy prototype generating logic 143 also may reside in the memory component 140 and may be configured to generate one or more decoy prototypes (e.g., second neural network logic to generate the one or more decoys). The scoring and ranking logic 144 includes logic to score and/or rank the plurality of prototypes generated by the prototype generating logic 142. The report generating logic 151 is configured to generate one or more reports including the plurality of prototypes and the one or more decoys (e.g., reports displayed on an electronic display).

The components illustrated in FIG. 5 are merely exemplary and are not intended to limit the scope of this disclosure. More specifically, while the components in FIG. 5 are illustrated as residing within the computing device 101, this is a non-limiting example. In some embodiments, one or more of the components may reside external to the computing device 101.

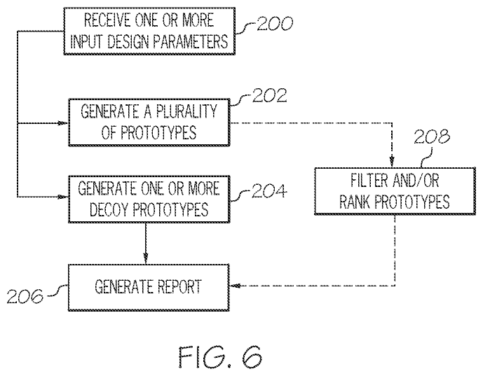

FIG. 6 illustrates an example method of generating a report including a plurality of prototypes and one or more decoy prototypes. At block 200, the system 100 receives one or more input design parameters. The input design parameters describe the product that is to be designed. The input design parameters may be in the form of a written description describing the parameters and or one or more images of a sample product(s). The input design parameters may include parameter values or range of values, for example.

At block 202, the system 100 uses the input design parameters that it received to generate a plurality of prototypes of the product. The system 100 may utilize a neural network, such as a GAN, trained on images of similar products to generate the plurality of prototypes that satisfy the input design parameters. Each prototype of the plurality of prototypes has a different configuration, such as a different size, shape, color, and/or the like.

In some embodiments, the plurality of prototypes are scored and/or ranked at block 208. The plurality of prototypes may be scored based on one or more factors, such as manufacturability, consumer preference, cost, and the like. Any method of scoring and/or ranking may be utilized. In other embodiments, the system does not score or rank the plurality of prototypes. Rather, the plurality of prototypes are provided to block 206 where the plurality of prototypes is provided within a report that is generated.

At block 204, one or more decoy prototypes are generated. The one or more decoy prototypes may drive sales to one or more desired products. The one or more input design parameters may include one or more desired products for which the designer wishes to create a decoy prototype. The system 100 then creates the one or more decoy prototypes such that the one or more decoy prototypes increases consumer preference toward one or more desired products.

At block 206, a report is generated that includes the plurality of prototypes and the one or more decoy prototypes. In some embodiments, only the plurality of prototypes is generated and thus no decoy prototypes are generated.

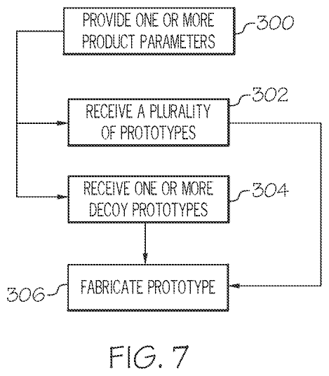

Referring now to FIG. 7, an example method of fabricating a prototype is illustrated. At block 300, a designer provides one or more input design parameters into a computer system 100 for generating prototypes. The input design parameters describe the product that is to be designed. The input design parameters may be in the form of a written description describing the parameters and or one or more images of a sample product(s). The input design parameters may include parameter values or range of values, for example.

At block 302, the designer receives the plurality of prototypes that is automatically generated by the system. The plurality of prototypes may be provided in a report generated by the system 100, for example. The system 100 may utilize a neural network, such as a GAN, trained on images of similar products to generate the plurality of prototypes that satisfy the input design parameters. Each prototype of the plurality of prototypes has a different configuration, such as a different size, shape, color, and/or the like.

At block 304, the designer receives one or more decoy prototypes from the system 100. The one or more decoy prototypes may drive sales to one or more desired products. The one or more input design parameters may include one or more desired products for which the designer wishes to create a decoy prototype. The system 100 then creates the one or more decoy prototypes such that the one or more decoy prototypes increases consumer preference toward one or more desired products. In some embodiments, no decoy prototypes are created.

At block 306, the designer fabricates a prototype. The designer may have used the plurality of prototypes as design inspiration for the prototype that is fabricated. Or, the designer may have like one of the prototypes that were generated so much that she fabricates it without further modifications. Fabricating the prototype means that the prototype is produced in physical form. Fabrication may include any physical steps, such as machining, molding, three-dimensional printing, semiconductor fabrication, assembly, and/or the like.

It should now be understood that embodiments of the present disclosure are directed to systems and methods for automatically generating initial prototypes and decoy prototypes for a product. The systems and methods described herein significantly reduce the amount of time to design a product by generating the initial prototypes for a designer's consideration. The systems and methods may produce one or more prototypes that the designer would not have thought of on her own. The prototypes may also be vetted for various aspects, such as competitive disadvantage, for example. The decoy prototypes may further be used to drive sales to other products offered in the marketplace.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computer-implemented method of creating a prototype, the method comprising:
receiving one or more input design parameters;
generating, using a first neural network, a plurality of prototypes based on the one or more input design parameters;
generating, using a second neural network, one or more decoy prototypes; and
presenting, by an electronic display, a report comprising at least a portion of the plurality of prototypes and at least one of the one or more decoy prototypes.

2. The computer-implemented method of claim 1, further comprising fabricating at least one select prototype of the plurality of prototypes and the one or more decoy prototypes.

3. The computer-implemented method of claim 1, wherein the first neural network comprises a generative adversarial network (GAN).

4. The computer-implemented method of claim 1, further comprising receiving, by the first neural network, historical product data for training the first neural network.

5. The computer-implemented method of claim 1, further comprising receiving, by the second neural network, competitive data relating to a product corresponding to the one or more input design parameters.

6. The computer-implemented method of claim 1, further comprising filtering the plurality of prototypes to eliminate one or more prototypes of the plurality of prototypes.

7. The computer-implemented method of claim 1, further comprising ranking the plurality of prototypes.

8. A system for creating a prototype, the system comprising:
one or more processors;
an electronic display;
one or more non-transitory memory modules storing computer-readable instructions that, when executed, cause the one or more processors to:
receive one or more input design parameters:
generate, using a first neural network, a plurality of prototypes based on the one or more input design parameters;
generate, using a second neural network, one or more decoy prototypes; and
present, by the electronic display, a report comprising at least a portion of the plurality of prototypes and at least one of the one or more decoy prototypes.

9. The system of claim 8, wherein the first neural network comprises a generative adversarial network (GAN).

10. The system of claim 8, wherein the computer-readable instructions further cause the one or more processors to receive, by the first neural network, historical product data for training the first neural network.

11. The system of claim 8, wherein the computer-readable instructions further cause the one or more processors to receive, by the second neural network, competitive data relating to a product corresponding to the one or more input design parameters.

12. The system of claim 8, wherein the computer-readable instructions further cause the one or more processors to filter the plurality of prototypes to eliminate one or more prototypes of the plurality of prototypes.

13. The system of claim 8, wherein the computer-readable instructions further cause the one or more processors to rank the plurality of prototypes.

14. The system of claim 8, further comprising a three-dimensional printer, wherein the three-dimensional printer is configured to fabricate at least a portion of at least one prototype of the plurality of prototypes.

15. A computer-implemented method of fabricating a prototype, the method comprising:
providing, to a first neural network, one or more input design parameters;
receiving, from the first neural network, a plurality of prototypes based on the one or more input design parameters;
receiving, from a second neural network, one or more decoy prototypes based at least in part on the one or more input design parameters; and
fabricating at least one select prototype of the plurality of prototypes and the one or more decoy prototypes.

16. The computer-implemented method of claim 15, wherein the first neural network comprises a generative adversarial network (GAN).

17. The computer-implemented method of claim 15, wherein the first neural network is trained on historical product data.

18. The computer-implemented method of claim 15, wherein the second neural network uses competitive data relating to a product corresponding to the one or more input design parameters to generate the one or more decoy prototypes.

19. The computer-implemented method of claim 15, further comprising filtering the plurality of prototypes to eliminate one or more prototypes of the plurality of prototypes.

20. The computer-implemented method of claim 15, wherein receiving the plurality of prototypes comprises receiving a report comprising ranked prototypes.
